(19) United States
(12) Patent Application Publication
(10) Pub. No.: US 2025/0069319 A1
(43) Pub. Date: Feb. 27, 2025

(54) MULTI-CHANNEL DISOCCLUSION MASK FOR INTERPOLATED FRAME RECERTIFICATION

(71) Applicant: ADVANCED MICRO DEVICES, INC., Santa Clara, CA (US)

(72) Inventor: Jimmy Stefan Petersson, Stockholm (SE)

(21) Appl. No.: 18/236,137

(22) Filed: Aug. 21, 2023

(51) Int. Cl. G06T 15/10; G06T 5/00; G06T 5/50; G06T 7/50; G06T 19/20

(52) U.S. Cl. CPC G06T 15/10; G06T 5/50; G06T 5/73; G06T 7/50; G06T 19/20; G06T 2219/2012

(57) ABSTRACT

An accelerator unit (AU) first generates and inserts interpolated frames into a set of rendered frames. For a current rendered frame of the set of rendered frames, the AU estimates positions in an interpolated frame and a previous rendered frame from which the pixels in the current rendered frame moved. Based on these estimated positions, the AU determines the changes in the depth values as the pixels move between frames. The AU then generates a multi-channel disocclusion mask using the determined differences in depth values that includes a first channel representing the levels of disocclusion as the pixels move from the previous rendered frame to the interpolated frame and a second channel representing the levels of disocclusion as the pixels move from the current frame to the interpolated frame. Using the multi-channel disocclusion mask, the AU recertifies the color values of the interpolated frame.

### BACKGROUND

Some graphics applications reduce or fix the frame rate at which frames are rendered in order to reduce the processing resources required to produce a set of rendered frames. To compensate for this reduction in frame rate, some processing systems implement frame interpolation techniques so as to generate one or more interpolated frames from two or more rendered frames within a set of rendered frames. These generated interpolated frames each represent frames that come temporally and spatially between two or more respective rendered frames. After generating the interpolated frames, the processing systems then insert the interpolated frames into the set of rendered frames. By inserting the interpolated frames into the set of rendered frames, the number of frames within the set of rendered frames is increased, which serves to increase the frame rate of the set of rendered frames. However, the occlusion of pixels within one or more rendered frames used to generate an interpolated frame increases the likelihood that visual artifacts are introduced in a resulting interpolated frame. These visual artifacts cause certain areas of the interpolated frames to be blurry or undefined and negatively impact user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to shade interpolated frames using a multi-channel disocclusion mask, in accordance with some embodiments.

FIG. 2 is a block diagram of a graphics pipeline implemented by an accelerator unit, in accordance with some embodiments.

FIG. 3 is a flow diagram of an example operation for shading an interpolated frame using a multi-channel disocclusion mask, in accordance with some embodiments.

FIG. 4 is a flow diagram of an example operation for generating a multi-channel disocclusion mask, in accordance with some embodiments.

FIG. 5 is a flow diagram of an example dilation operation, in accordance with some embodiments.

FIG. 6 is a flow diagram of an example method for shading an interpolated frame using a multi-channel disocclusion mask, in accordance with some embodiments.

### DETAILED DESCRIPTION

Some processing systems are configured to execute applications that render sets of rendered frames to be presented on a display. Each of these rendered frames, for example, represents a scene with one or more graphics objects (e.g., groups of primitives) as viewed by a respective viewpoint (e.g., camera view). In this way, as the set of rendered frames is displayed, the viewpoint of the scene changes which causes pixels representing the graphics objects to be viewed at a first position when a first rendered frame is displayed and at a second position when a second rendered frame is displayed. To help improve processing efficiency, some applications are configured to lower the frame rate at which these rendered frames are rendered such that the resulting set of rendered frames has a reduced number of rendered frames and requires fewer processing resources to render. However, lowering the frame rate in this way causes the set of rendered frames to display at a lower frame rate, causing movement of the pixels representing the graphics objects to appear less smooth and negatively impacting user experience. To this end, systems and techniques disclosed herein include a processing system configured to generate one or more interpolated frames that each represent a scene with a respective viewpoint that is temporally between, spatially between, or both temporally and spatially between two or more rendered frames of the set of rendered frames. For example, based on a first rendered frame (e.g., a previous rendered frame) and a second rendered frame (e.g., a current rendered frame) a processing system is configured to generate an interpolated frame that represents a scene with a respective viewpoint that is temporally between, spatially between, or both temporally and specially between the first and second rendered frames. After generating the interpolated frame, the processing system inserts the interpolated frame into the set of rendered frames between the first and second rendered frames used to generate the interpolated frame. After inserting one or more interpolated frames into the set of rendered frames, the processing system displays the set of rendered frames. Due to the set of rendered frames including one or more interpolated frames, the number of frames within the set of rendered frames is increased, increasing the frame rate of the set of rendered frames when it is displayed. Because the frame rate of the set of rendered frames is increased, the motion of the pixels representing the graphics objects appears smoother when displayed, which improves user experience.

However, the disocclusion of pixels between a first rendered frame and an interpolated frame or the second rendered frame and the interpolated frame increases the risk of introducing visual artifacts in the interpolated frame. That is to say, when pixels that are occluded in one rendered frame used to generate an interpolated frame are disoccluded in a second rendered frame used to generate an interpolated frame, the chance of introducing visual artifacts in a resulting interpolated frame is increased. “Disocclusion,” as used herein represents a pixel that becomes less occluded (e.g., less obscured) in a subsequent or previous frame. Such disocclusion, for example, increases the risk of introducing ghosting artifacts into an interpolated frame. These ghosting artifacts cause pixels representing the graphics objects in the interpolated frame to appear blurry or undefined and negatively impact user experience. As such, systems and techniques disclosed herein are directed to reducing the number of visual artifacts in interpolated frames.

To reduce the number of visual artifacts in interpolated frames, a processing system is configured to first estimate the positions of pixels within an interpolated frame that moved to current locations in a first rendered frame (e.g., a current rendered frame used to generate the interpolated frame). Further, the processing system estimates the positions of pixels in a second rendered frame (e.g., a previous frame used to generate the interpolated frame) that moved to the estimated locations in the interpolated frame. After determining these positions in the interpolated frame and the second rendered frame, the processing system determines the depth values of the pixels at the estimated positions in the first rendered frame and the depth values of the pixels at the estimated positions in the interpolated frame. The processing system then determines disocclusion values representing how disoccluded the pixels become from the first rendered frame to the interpolated frame by determining a difference between the depth values of the pixels at the estimated positions in the first rendered frame and the depth values of the pixels at the estimated positions in the interpolated frame. As an example, the processing system compares the difference in the depth values of the pixels to a threshold value to determine disocclusion values (e.g., levels of disocclusion). Likewise, the processing system determines disocclusion values representing how disoccluded the pixels become from the second rendered frame to the interpolated frame by determining a difference between the depth values of the pixels at the estimated positions of the interpolated frame and the depth values of the pixels at the current positions of the second rendered frame.

After generating the levels of disocclusion, the processing system generates a multi-channel disocclusion mask representing how disoccluded pixels become as they move from a first rendered frame to an interpolated frame and from the second rendered frame to the interpolated frame. To this end, the processing system populates a first channel of the multi-channel disocclusion mask with values representing the levels of disocclusion of pixels moving from the first rendered frame to the interpolated frame. Further, the processing system populates a second channel of the multi-channel disocclusion mask with values representing the levels of disocclusion of pixels moving from the second rendered frame to the interpolated frame.

Using the multi-channel disocclusion mask, the processing system then shades the interpolated frame. That is to say, the processing system recertifies the color values of the interpolated frame based on the multi-channel disocclusion mask. The processing system recertifies the color values of the interpolated frame, for example, by modifying the color values of the rendered frames used to generate the interpolated frame and then regenerating the color values of interpolated frame using the modified color values of the rendered frames. As an example, the processing system compares each value in the first channel of the multi-channel disocclusion mask to a threshold disocclusion value. Based on the comparison indicating that the pixel was disoccluded by a threshold amount moving from the first rendered frame to the interpolated frame, the processing system determines that the color value of the pixel in the first rendered frame is not reliable when calculating the color values of the interpolated frame. To this end, the processing system reduces the influence of the color value of the pixel in the first rendered frame when regenerating the color values for the interpolated frame by, for example, modifying the color value of the pixel in the first rendered frame. Further, the processing system compares each value in the second channel of the multi-channel disocclusion mask to a threshold disocclusion value. Based on the comparison indicating that the pixel was disoccluded by a threshold amount moving from the second rendered frame to the interpolated frame, the processing system determines that the color value of the pixel in the second rendered frame is not reliable when calculating the color values of the interpolated frame. To this end, the processing system reduces the influence of the color value of the pixel in the second rendered frame when regenerating the color values for the interpolated frame by, for example, modifying the color value of the pixel in the second rendered frame.

The processing system then recalculates the color values of the interpolated frame using the modified color values of the pixels in the first and second rendered frames. By reducing the influence of pixels in the first and second rendered frames that become disoccluded in the interpolated frame when calculating the color values of the interpolated frame, the likelihood that any visual artifacts are introduced in the interpolated frame is reduced. As such, a resulting interpolated frame contains fewer visual artifacts when compared to interpolated frames generated from the unmodified color values of the first and second rendered frames. Due to the interpolated frame having fewer visual artifacts, the motion of pixels representing graphics objects in the interpolated frame appears smoother, improving user experience.

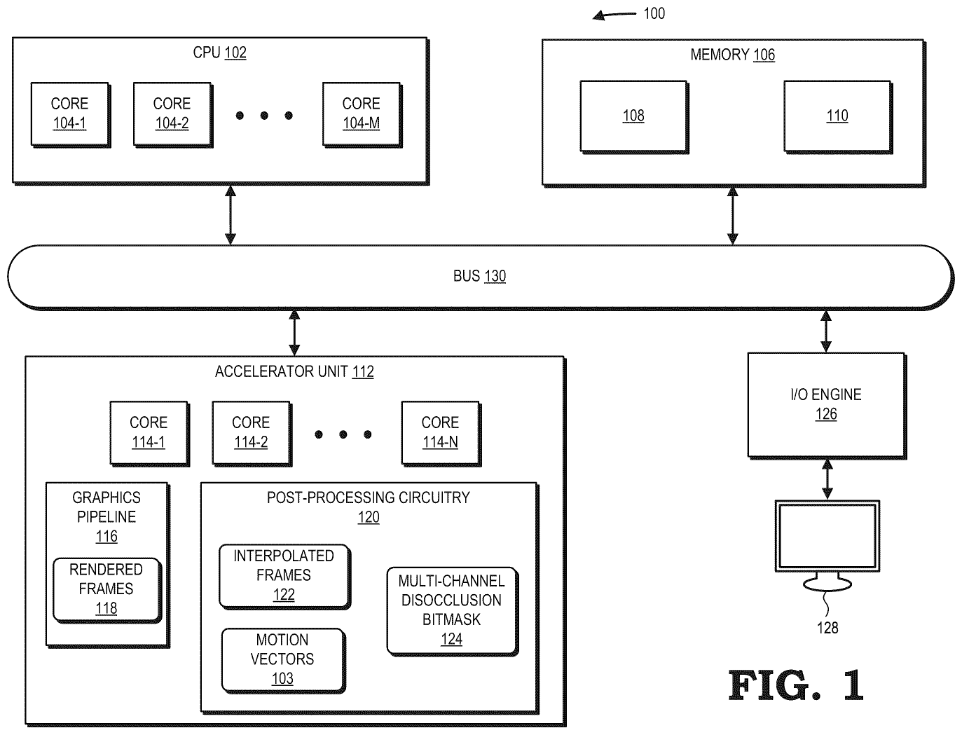

Referring now to FIG. 1, a processing system 100 configured to shade interpolated frames using a multi-channel disocclusion mask is presented, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 130 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. AU 112 is configured to render a set of rendered frames 118 each representing respective scenes within a screen space (e.g., the space in which a scene is displayed) according to one or more applications 110 for presentation on a display 128. As an example, AU 112 renders graphics objects (e.g., sets of primitives) for a scene to be displayed so as to produce pixel values representing a rendered frame 118. AU 112 then provides the rendered frame 118 (e.g., pixel values) to display 128. These pixel values, for example, include color values (YUV color values, RGB color values), depth values (z-values), or both. After receiving the rendered frame 118, display 128 uses the pixel values of the rendered frame 118 to display the scene including the rendered graphics objects. To render the graphics objects, AU 112 implements processor cores 114-1 to 114-N that execute instructions concurrently or in parallel. For example, AU 112 executes instructions, operations, or both from a graphics pipeline 116 using processor cores 114 to render one or more graphics objects. A graphics pipeline 116 includes, for example, one or more steps, stages, or instructions to be performed by AU 112 in order to render one or more graphics objects for a scene. As an example, example graphics pipeline 200 includes data indicating an input assembler stage, vertex shader stage, hull shader stage, tessellator stage, domain shader stage, geometry shader stage, rasterizer stage, pixel shader stage, output merger stage, or any combination thereof to be performed by one or more processor cores 114 of AU 112 in order to render one or more graphics objects for a scene to be displayed.

In embodiments, one or more processor cores 114 of AU 112 each operate as a compute unit configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each functioning as a compute unit that includes one or more SIMD units to perform operations for one or more instructions from a graphics pipeline 116. To facilitate the performance of operations by the compute units, AU 112 includes one or more command processors (not shown for clarity). Such command processors, for example, include circuitry configured to execute one or more instructions from a graphics pipeline 116 by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, AU 112 executes the instructions for the video tasks, physical simulation tasks, computational tasks, and fluid dynamics tasks. AU 112 then stores information in the memory 106 such as the results of the executed instructions.

According to embodiments, AU 112 is configured to render the set of rendered frames 118 at a frame rate based on, for example, an application 110 being executed by processing system 100. For example, AU 112 executes instructions from the application 110 such that AU 112 renders the set of rendered frames 118 at a frame rate indicated by the instructions. To improve the frame rate of the set of rendered frame 118 when the rendered frames 118 are displayed on display 128, AU 112 is configured to generate one or more interpolated frames 122 and insert respective interpolated frames 122 between corresponding rendered frames 118. Such interpolated frames 122, for example, include frames representing a scene that is temporally between, spatially between, or both a first rendered frame of the set of rendered frames 118 and a second frame of the set of rendered frames 118. For example, an interpolated frame 122 represents a scene temporally between, spatially between, or both a current frame of the set of rendered frames 118 and a previous frame of the set of rendered frames 118 (e.g., the frame immediately preceding the current frame in the set of rendered frames 118). To generate one or more interpolated frames 122, in embodiments, AU 112 includes post-processing circuitry 120. Post-processing circuitry 120, for example, is configured to generate an interpolated frame 122 representing a scene temporally between, spatially between, or both a first frame (e.g., current frame) of the set of rendered frames 118 and a second frame (e.g., immediately preceding frame) of the set of rendered frames based on the color values of the first and second frames and the depth values of the first and second frames. For example, based on the color values of the first and second frames and the depth values of the first and second frames, post-processing circuitry 120 generates one or more motion vectors 103. A motion vector 103, for example, represents the movement of one or more graphics objects from a first frame (e.g., previous frame) and a second frame (e.g., current frame). As an example, a motion vector 103 represents the movement of one or more pixels from a first position in a first frame to a second position in a second frame. To generate such motion vectors 103, post-processing circuitry 120 is configured to implement one or more motion estimation techniques, for example, block-matching algorithms, phase correlation methods, pixel recursive algorithms, optical flow methods, or any combination thereof, to name a few.

Once determining one or more motion vectors 103, post-processing circuitry 120 then uses the motion vectors 103, the color values of the first and second frames, and the depth values of the first and second frames to determine an interpolated frame 122 representing a scene temporally between, spatially between, or both the first frame and the second frame. For example, based on the motion vectors 103, the color values of the first and second frames, and the depth values of the first and second frames, post-processing circuitry 120 is configured to synthesize pixel values (e.g., color values and depth values) for each pixel of an interpolated frame 122. To this end, in embodiments, post-processing circuitry 120 implements one or more machine machine-learning models, neural networks (e.g., artificial neural networks, convolution neural networks, recurrent neural networks), or both configured to output pixel values for each pixel of an interpolated frame 122 based on receiving the motion vectors 103, the color values of the first and second frames, the depth values of the first and second frames, or any combination thereof as inputs. For example, in some embodiments, post-processing circuitry 120 is configured to implement a depth-aware frame interpolation neural network to synthesize pixel values for an interpolated frame 122. After generating the pixel values of the interpolated frame 122, post-processing circuitry 120 inserts the interpolated frame 122 into the set of rendered frames 118. For example, post-processing circuitry 120 inserts the interpolated frame 122 between the first frame and the second frame within the set of rendered frames 118. AU 112 then provides the set of rendered frames 118 with one or more interpolated frames 122 to display 128. In response to receiving the set of rendered frames 118 with one or more interpolated frames 122, display 128 displays each rendered frame and interpolated frame 122 of the set of rendered frames 118 such that the displayed frames have a greater frame rate when compared to a set of rendered frames 118 without any interpolated frames 122. That is to say, because inserting the interpolated frames 122 into the set of rendered frames 118 increases the number of frames in the set of rendered frames 118, the frame rate of the set of rendered frames 118 when displayed is increased.

However, in embodiments, interpolated frames 122 generated by post-processing circuitry 120 include one or more visual artifacts due to properties of the rendered frames used to generate the interpolated frames 122. As an example, based on one or more pixels moving from the first frame to the second, the second frame to the first, or both becoming disoccluded, an interpolated frame 122 generated from the first and second frames includes one or more ghosting artifacts. Such ghosting artifacts, for example, cause graphics objects in the interpolated frame 122 to appear blurry or undefined and negatively impact user experience. To help reduce the number of these visual artifacts in interpolated frames 122, post-processing circuitry 120 is configured to shade the interpolated frames 122 based on multi-channel disocclusion mask 124. That is to say, post-processing circuitry 120 is configured to recertify the pixel values of an interpolated frame 122 based on a multi-channel disocclusion mask 124.

A multi-channel disocclusion mask 124, for example, includes a data structure indicating the levels of disocclusion of pixels between an interpolated frame 122 and two or more rendered frames 118. That is to say, a multi-channel disocclusion mask 124 indicates how disoccluded pixels become between an interpolated frame 122 and two or more rendered frames 118. In embodiments, a multi-channel disocclusion mask 124 includes two or more channels each including data indicating the levels of disocclusion of pixels between an interpolated frame 122 and a respective rendered frame 118. As an example, a multi-channel disocclusion mask 124 includes a first channel including data (e.g., values) representing the levels of disocclusion of pixels between an interpolated frame 122 and a first rendered frame (e.g., current rendered frame) used to generate the interpolated frame 122 and a second channel including data (e.g., values) representing the levels of disocclusion of pixels between an interpolated frame 122 and a second rendered frame (e.g., previous rendered frame) used to generate the interpolated frame 122. A level of disocclusion, for example, represents how unobscured a pixel becomes moving from a first position in a first frame to a second position in a second frame. As an example, within a first channel of multi-channel disocclusion mask 124 representing the levels of disocclusion of pixels between an interpolated frame 122 and a previous rendered frame, a first value (e.g., 0) indicates that the pixel was entirely occluded in the previous rendered frame and is now disoccluded in the interpolated frame 122 and a second value (e.g., 1) indicates the pixel was fully visible in the previous rendered frame and is also fully visible in the interpolated frame 122. Values between the first value and the second value indicate that the pixel was visible in the previous rendered frame to an extent proportional to the value. Within a second channel of multi-channel disocclusion mask 124 representing the levels of disocclusion of pixels between an interpolated frame 122 and a current rendered frame, the first value indicates that the pixel is entirely occluded in the current rendered frame and was disoccluded in the interpolated frame 122 and the second value indicates the pixel was fully visible in the interpolated frame 122 and is fully visible in the current rendered frame. Values between the first value and the second value indicate that the pixel is visible in the current frame to an extent proportional to the value.

In embodiments, post-processing circuitry 120 is configured to generate a multi-channel disocclusion mask 124 based on the pixel values (e.g., depth values) of a current rendered frame (e.g., the second rendered frame). For example, to generate a multi-channel disocclusion mask 124 representing the levels of disocclusion of pixels between a first (e.g., previous) rendered frame and an interpolated frame 122 and between a second (e.g., current) rendered frame and the interpolated frame 122, post-processing circuitry 120 estimates the locations (e.g., second locations) within the interpolated frame 122 from which pixels in the second rendered frame move based on the depth values of the second rendered frame and one or more motion vectors 103 used to generate the interpolated frame 122. Likewise, post-processing circuitry 120 estimates the locations (e.g., first locations) within the first rendered frame from which pixels in the interpolated frames 122 moved based on the depth values of the second rendered frame and one or more motion vectors 103 used to generate the interpolated frame 122. Post-processing circuitry 120 then generates a first channel of the multi-channel disocclusion mask 124 based on the depth values of pixels at the estimated second locations in the interpolated frame 122 and the depth values of pixels at the estimated first locations in the first rendered frame. Further, post-processing circuitry 120 generates a second channel of the multi-channel disocclusion mask 124 based on the depth values of the pixels at the estimated second locations in interpolated frame 122 and the depth values of pixels at current locations in the second rendered frame. As an example, to generate a channel of the multi-channel disocclusion mask 124, post-processing circuitry 120 determines the depth values at the estimated locations within a respective frame. Post-processing circuitry 120 then determines the differences between the depth values of the pixels at the estimated locations within the respective frame and the depth values of the pixels in the interpolated frame 122. Next, post-processing circuitry 120 compares these differences (e.g., deltas) in depth values to a separation threshold.

As an example, post-processing circuitry 120 compares the differences in depth values to an Akeley separation constant, kₛₑₚ, representing a separation threshold. The Akeley separation constant, for example, provides a minimum distance between two objects represented in a floating point depth buffer, which post-processing circuitry 120 uses to determine if pixels were originally distinct from one another. In embodiments, based on post-processing circuitry 120 determining that the difference between the depth values of one or more pixels is greater than the separation threshold, post-processing circuitry 120 determines the pixels represent distinct objects. Based on post-processing circuitry 120 determining that the difference between the depth values of one or more pixels is not greater than the separation threshold, post-processing circuitry 120 is unable to confidently determine that the pixels represent distinct objects. According to this comparison, post-processing circuitry 120 then stores a value in a corresponding channel of the multi-channel disocclusion mask 124 for the pixel in a range between a first value (e.g., 0) and a second value (e.g., 1), with the second value (e.g., 1), for example, mapping to a difference that is greater than or equal to the separation value.

After generating a multi-channel disocclusion mask 124 representing the levels of disocclusion of pixels between an interpolated frame 122 and two or more rendered frames 118, post-processing circuitry 120 uses the multi-channel disocclusion mask 124 to shade the interpolated frame 122. That is to say, post-processing circuitry 120 recertifies the color values of the interpolated frame 122 based on the multi-channel disocclusion mask 124. As an example, post-processing circuitry 120 recertifies the color values of the interpolated frame based on a first channel of the multi-channel disocclusion mask 124, color values of a first (e.g., previous) rendered frame, a second channel of the multi-channel disocclusion mask 124, color values of a second (e.g., current) rendered frame, and motion vectors 103. For example, in embodiments, to recertify the color values of the interpolated frame 122, post-processing circuitry 120 compares the values in a first channel of the multi-channel disocclusion mask 124 to a first disocclusion threshold representing, for example, a level of disocclusion (e.g., a change in the level of occlusion) between frames. Based on a value in the first channel of the multi-channel disocclusion mask 124 being less than the first disocclusion threshold, post-processing circuitry 120 reduces the influence of the color value of the associated pixel in the first rendered frame when determining the color value of the pixel for the interpolated frame 122. That is to say, based on the comparison indicating that a pixel was at least partially occluded in the first rendered frame and was disoccluded by a threshold amount in the interpolated frame 122, post-processing circuitry 120 reduces the influence of the color value of that pixel in the first rendered frame when determining the color value of the pixel for the interpolated frame 122. As an example, to reduce the influence of the color value of that pixel in the first rendered frame, post-processing circuitry 120 modulates the color value by the first channel of multi-channel disocclusion mask 124, discards the color value, applies a weight to the color value, or any combination thereof. After reducing the value of one or more pixels of the first rendered frame, for example, post-processing circuitry 120 produces a first set of modified color values representing the color values of pixels in the first rendered frame as modified by post-processing circuitry 120.

Additionally, post-processing circuitry 120 compares the values in a second channel of the multi-channel disocclusion mask 124 to a second occlusion threshold representing, for example, a level of disocclusion (e.g., a change in the level of occlusion) between frames. Based on a value in the second channel of the multi-channel disocclusion mask 124 being less than the second disocclusion threshold, post-processing circuitry 120 reduces the influence of the color value of an associated pixel in the second rendered frame when determining the color value of the pixel for the interpolated frame 122. That is to say, based on the comparison indicating that a pixel was occluded in the interpolated frame 122 but was disoccluded in the current rendered frame by a threshold amount, post-processing circuitry 120 reduces the influence of the color value of that pixel in the second rendered frame when determining the color value of the pixel for the interpolated frame 122. For example, to reduce the influence of the color value of that pixel in the second rendered frame, post-processing circuitry 120 modulates the color value by the second channel of multi-channel disocclusion mask 124, discards the color value, applies a weight to the color value, or any combination thereof. In some embodiments, the first occlusion threshold is equal to the second occlusion threshold while in other embodiments, the first occlusion threshold is different from the second occlusion threshold. After reducing the value of one or more pixels of the second rendered frame, for example, post-processing circuitry 120 produces a second set of modified color values representing the color values of the pixels in the second rendered frame as modified by post-processing circuitry 120.

After comparing each value of each channel of the multi-channel disocclusion mask 124 to a respective occlusion threshold, post-processing circuitry 120 recalculates the color values for the interpolated frame 122. For example, post-processing circuitry 120 recalculates the color values for the interpolated frame 122 based on the first set of modified color values (e.g., modified color values of the first rendered frame), second set of modified color values (e.g., modified color values of the second rendered frame), and one or more motion vectors 103. In this way, post-processing circuitry 120 reduces the influence of occluded pixels in the rendered frames that become disoccluded in a resulting interpolated frame 122. By reducing the influence of these occluded pixels in the rendered frames, the number of ghosting artifacts in a resulting interpolated frame 122 is reduced, helping to improve the clarity of the interpolated frame 122 and improve user experience.

In some embodiments, processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the memory 106, AU 112, or the central processing unit (CPU) 102.

In embodiments, processing system 100 also includes CPU 102 that is connected to the bus 130 and therefore communicates with AU 112 and the memory 106 via the bus 130. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to AU 112.

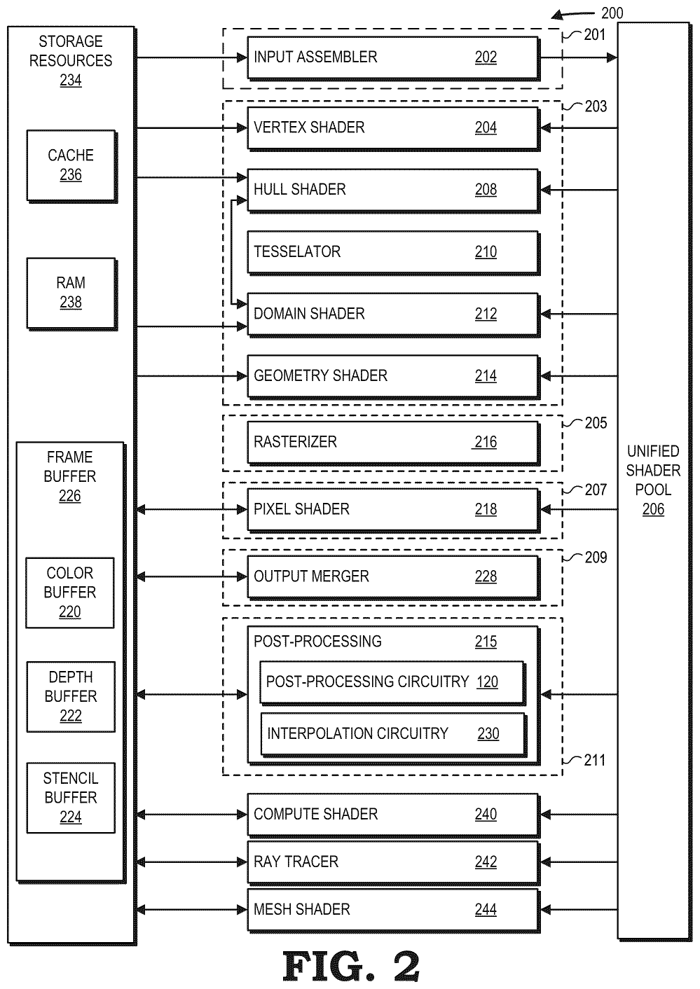

Referring now to FIG. 2, a block diagram of an example graphics pipeline 200 is presented, in accordance with some embodiments. In embodiments, example graphics pipeline 200 is implemented in processing system 100 as graphics pipeline 116. In embodiments, example graphics pipeline 200 is configured to render graphics objects as images that depict a scene which has three-dimensional geometry in virtual space (also referred to herein as “screen space”), but potentially a two-dimensional geometry. Example graphics pipeline 200 typically receives a representation of a three-dimensional scene, processes the representation, and outputs a two-dimensional raster image. These stages of example graphics pipeline 200 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

According to embodiments, example graphics pipeline 200 has access to storage resources 234 (also referred to herein as “storage components”). Storage resources 234 include, for example, a hierarchy of one or more memories or caches that are used to implement buffers and store vertex data, texture data, and the like for example graphics pipeline 200. In some embodiments, storage resources 234 are implemented within processing system 100 using respective portions of system memory 106. In embodiments, storage resources 234 include or otherwise have access to one or more caches 236, one or more random access memory (RAM) units 238, video random access memory unit(s) (not pictured for clarity), one or more processor registers (not pictured for clarity), and the like, depending on the nature of data at the particular stage of example graphics pipeline 200. Accordingly, it is understood that storage resources 234 refer to any processor-accessible memory utilized in the implementation of example graphics pipeline 200.

Example graphics pipeline 200, for example, includes stages that each perform respective functionalities. For example, these stages represent subdivisions of functionality of example graphics pipeline 200. Each stage is implemented partially or fully as shader programs executed by AU 112. According to embodiments, stages 201 and 203 of example graphics pipeline 200 represent the front-end geometry processing portion of example graphics pipeline 200 prior to rasterization. Stages 203 to 211 represent the back-end pixel processing portion of example graphics pipeline 200.

During input assembler stage 201 of example graphics pipeline 200, an input assembler 202 is configured to access information from the storage resources 234 that is used to define objects that represent portions of a model of a scene. For example, in various embodiments, the input assembler 202 includes circuitry configured to read primitive data (e.g., points, lines and/or triangles) from user-filled buffers (e.g., buffers filled at the request of software executed by processing system 100, such as an application 110) and assembles the data into primitives that will be used by other pipeline stages of the example graphics pipeline 200. “User,” as used herein, refers to an application 110 or other entity that provides shader code and three-dimensional objects for rendering to example graphics pipeline 200. In embodiments, the input assembler 202 is configured to assemble vertices into several different primitive types (e.g., line lists, triangle strips, primitives with adjacency) based on the primitive data include in the user-filled buffers and formats the assembled primitives for use by the rest of example graphics pipeline 200.

According to embodiments, example graphics pipeline 200 operates on one or more virtual objects defined by a set of vertices set up in the screen space and having geometry that is defined with respect to coordinates in the scene. For example, the input data utilized in example graphics pipeline 200 includes a polygon mesh model of the scene geometry whose vertices correspond to the primitives processed in the rendering pipeline in accordance with aspects of the present disclosure, and the initial vertex geometry is set up in the storage resources 234 during an application stage implemented by, for example, CPU 102.

During the vertex processing stage 203 of example graphics pipeline 200, one or more vertex shaders 204 are configured to process vertexes of the primitives assembled by the input assembler 202. For example, a vertex shader 204 includes circuitry configured to first receive a single vertex of a primitive as an input and outputs a single vertex. The vertex shader 204 then performs various per-vertex operations such as transformations, skinning, morphing, per-vertex lighting, or any combination thereof, to name a few. Transformation operations include various operations to transform the coordinates (e.g., X-Y coordinate, Z-depth values) of the vertices. These operations include, for example, one or more modeling transformations, viewing transformations, projection transformations, perspective division, viewport transformations, or any combination thereof. Herein, such transformations are considered to modify the coordinates or “position” of the vertices on which the transforms are performed. Other operations of the vertex shader 204 modify attributes other than the coordinates.

In embodiments, one or more vertex shaders 204 are implemented partially or fully as vertex shader programs to be executed on one or more processor cores 114 (e.g., one or more processor cores 114 operating as compute units). Some embodiments of shaders such as the vertex shader 204 implement massive single-instruction-multiple-data (SIMD) processing so that multiple vertices are processed concurrently. In at least some embodiments, example graphics pipeline 200 implements a unified shader model so that all the shaders included in example graphics pipeline 200 have the same execution platform on the shared massive SIMD units of the processor cores 114. In such embodiments, the shaders, including one or more vertex shaders 204, are implemented using a common set of resources that is referred to herein as the unified shader pool 206.

During the vertex processing stage 203, in some embodiments, one or more vertex shaders 204 perform additional vertex processing computations that subdivide primitives and generate new vertices and new geometries in the screen space. These additional vertex processing computations, for example, are performed by one or more of a hull shader 208, a tessellator 210, a domain shader 212, and a geometry shader 214. The hull shader 208, for example, includes circuitry configured to operate on input high-order patches or control points that are used to define the input patches. Additionally, the hull shader 208 outputs tessellation factors and other patch data. According to embodiments, within example graphics pipeline 200, primitives generated by the hull shader 208 are provided to the tessellator 210. The tessellator 210 includes circuitry configured to receive objects (such as patches) from the hull shader 208 and generate information identifying primitives corresponding to the input object, for example, by tessellating the input objects based on tessellation factors provided to the tessellator 210 by the hull shader 208. Tessellation, as an example, subdivides input higher-order primitives such as patches into a set of lower-order output primitives that represent finer levels of detail (e.g., as indicated by tessellation factors that specify the granularity of the primitives produced by the tessellation process). As such, a model of a scene is represented by a smaller number of higher-order primitives (e.g., to save memory or bandwidth) and additional details are added by tessellating the higher-order primitive.

The domain shader 212 includes circuitry configured to receive a domain location, other patch data, or both as inputs. The domain shader 212 is configured to operate on the provided information and generate a single vertex for output based on the input domain location and other information. The geometry shader 214 includes circuitry configured to receive a primitive as an input and generate up to four primitives based on the input primitive. In some embodiments, the geometry shader 214 retrieves vertex data from storage resources 234 and generates new graphics primitives, such as lines and triangles, from the vertex data in storage resources 234. In particular, the geometry shader 214 retrieves vertex data for a primitive and generates one or more primitives. To this end, for example, the geometry shader 214 is configured to operate on a triangle primitive with three vertices. A variety of different types of operations can be performed by the geometry shader 214, including operations such as point sprint expansion, dynamic particle system operations, fur-fin generation, shadow volume generation, single pass render-to-cubemap, per-primitive material swapping, per-primitive material setup, or any combination thereof. According to embodiments, the hull shader 208, the domain shader 212, the geometry shader 214, or any combination thereof are implemented as shader programs to be executed on the processor cores 114, whereas the tessellator 210, for example, is implemented by fixed-function hardware.

Once front-end processing (e.g., stages 201, 203) of example graphics pipeline 200 is complete, the scene is defined by a set of vertices which each have a set of vertex parameter values stored in the storage resources 234. In certain implementations, the vertex parameter values output from the vertex processing stage 203 includes positions defined with different homogeneous coordinates for different zones.

As described above, stages 205 to 211 represent the back-end processing of example graphics pipeline 200. The rasterizer stage 205 includes a rasterizer 216 having circuitry configured to accept and rasterize simple primitives that are generated upstream. The rasterizer 216 is configured to perform shading operations and other operations such as clipping, perspective dividing, scissoring, viewport selection, and the like. In embodiments, the rasterizer 216 is configured to generate a set of pixels that are subsequently processed in the pixel processing/shader stage 207 of the example graphics processing pipeline. In some implementations, the set of pixels includes one or more tiles. In one or more embodiments, the rasterizer 216 is implemented by fixed-function hardware.

The pixel processing stage 207 of example graphics pipeline 200 includes one or more pixel shaders 218 that include circuitry configured to receive a pixel flow (e.g., the set of pixels generated by the rasterizer 216) as an input and output another pixel flow based on the input pixel flow. To this end, a pixel shader 218 is configured to calculate pixel values for screen pixels based on the primitives generated upstream and the results of rasterization. In embodiments, the pixel shader 218 is configured to apply textures from a texture memory, which, according to some embodiments, is implemented as part of the storage resources 234. The pixel values generated by one or more pixel shaders 218 include, for example, color values, depth values, and stencil values, and are stored in one or more corresponding buffers, for example, a color buffer 220, a depth buffer 222, and a stencil buffer 224, respectively. The combination of the color buffer 220, the depth buffer 222, the stencil buffer 224, or any combination thereof is referred to as a frame buffer 226. In some embodiments, example graphics pipeline 200 implements multiple frame buffers 226 including front buffers, back buffers and intermediate buffers such as render targets, frame buffer objects, and the like. Operations for the pixel shader 218 are performed by a shader program that executes on the processor cores 114.

According to embodiments, the pixel shader 218, or another shader, accesses shader data, such as texture data, stored in the storage resources 234. Such texture data defines textures which represent bitmap images used at various points in example graphics pipeline 200. For example, the pixel shader 218 is configured to apply textures to pixels to improve apparent rendering complexity (e.g., to provide a more “photorealistic” look) without increasing the number of vertices to be rendered. In another instance, the vertex shader 204 uses texture data to modify primitives to increase complexity, by, for example, creating or modifying vertices for improved aesthetics. AS an example, the vertex shader 204 uses a height map stored in storage resources 234 to modify displacement of vertices. This type of technique can be used, for example, to generate more realistic-looking water as compared with textures only being used in the pixel processing stage 207, by modifying the position and number of vertices used to render the water. The geometry shader 214, in some embodiments, also accesses texture data from the storage resources 234.

Within example graphics pipeline 200, the output merger stage 209 includes an output merger 228 accepting outputs from the pixel processing stage 207 and merges these outputs. As an example, in embodiments, output merger 228 includes circuitry configured to perform operations such as z-testing, alpha blending, stenciling, or any combination thereof on the pixel values of each pixel received from the pixel shader 218 to determine the final color for a screen pixel. For example, the output merger 228 combines various types of data (e.g., pixel values, depth values, stencil information) with the contents of the color buffer 220, depth buffer 222, and, in some embodiments, the stencil buffer 224 and stores the combined output back into the frame buffer 226. The output of the output merger stage 209 can be referred to as rendered pixels that collectively form a rendered frame 118. In one or more implementations, the output merger 228 is implemented by fixed-function hardware.

In embodiments, example graphics pipeline 200 includes a post-processing stage 211 implemented after the output merger stage 209. During the post-processing stage 211, post-processing circuitry 120 operates on the rendered frame stored (or individual pixels) stored in the frame buffer 226 to apply one or more post-processing effects, such as ambient occlusion or tonemapping, prior to the frame being output to the display. The post-processed frame is written to a frame buffer 226, such as a back buffer for display or an intermediate buffer for further post-processing. The example graphics pipeline 200, in some embodiments, includes other shaders or components, such as a computer shader 240, a ray tracer 242, a mesh shader 244, and the like, which are configured to communicate with one or more of the other components of example graphics pipeline 200.

In embodiments, to help improve the frame rate of a set of rendered frame 118 rendered by the example graphics pipeline 200, post-processing stage 215 includes interpolation circuitry 230 generating one or more interpolated frames 122. Interpolation circuitry 230, according to some embodiments, is implemented within or otherwise connected to post-processing circuitry 120. To generate an interpolated frame 122, interpolation circuitry 230 is configured to generate one or more motion vectors 103 based on two or more rendered frames 118. For example, interpolation circuitry 230 first retrieves pixel data (e.g., color values, depth values) of a first rendered frame (e.g., current frame) from respective color buffers 220 and depth buffers 222 associated with the first rendered frame. Further, interpolation circuitry 230 retrieves pixel data of a second rendered frame (e.g., previous frame) from respective color buffers 220 and depth buffers 222 associated with the second rendered frame. In embodiments, the second rendered frame is the frame within a set of rendered frames 118 immediately preceding the first frame. Interpolation circuitry 230 then implements one or more motion estimation techniques based on the pixel values associated with the first rendered frame and the pixel values associated with the second rendered frame to output one or more motion vectors 103. Based on one or of the determined motion vectors 103, interpolation circuitry 230 is configured to generate pixel values (e.g., color values, depth values, stencil values) for an interpolated frame 122 that represents a scene temporally between, spatially between, or both the first rendered frame and the second rendered frame. As an example, interpolation circuitry 230 is configured to generate pixel values for an interpolated frame 122 that represents a viewpoint of the scene that is temporally between, spatially between, or both the viewpoints of the first rendered frame and the second rendered frame. After generating the pixel values for the interpolated frame 122, interpolation circuitry 230 stores the pixel values in respective color buffers 220, depth buffers 222, and stencil buffers 224.

To help remove visual artifacts (e.g., ghosting artifacts) in the generated interpolated frame 122, interpolation circuitry 230 is configured to generate a multi-channel disocclusion mask 124. For example, in embodiments, a first channel of multi-channel disocclusion mask 124 has a first channel representing the levels of disocclusion of pixels between the second rendered frame (e.g., previous rendered frame) and the interpolated frame 122 and a second channel representing the levels of disocclusion of pixels between the interpolated frame 122 and the first rendered frame (e.g., current rendered frame). In embodiments, interpolation circuitry 230 is configured to generate a first channel of the multi-channel disocclusion mask 124 by comparing the depth values of the pixels of the first rendered frame to the depth values of the interpolated frame 122. As an example, interpolation circuitry 230 compares these differences between the depth values of the pixels of the first rendered frame and the depth values of the interpolated frame 122 to a separation threshold (e.g., Akeley separation constant). Based on the comparison, interpolation circuitry 230 determines respective values for one or more pixels representing the level of disocclusion (e.g., how disoccluded the pixel became) from the viewpoint of first rendered frame to the viewpoint of the interpolated frame 122.

Additionally, interpolation circuitry 230 is configured to generate a second channel of the multi-channel disocclusion mask 124 by comparing the depth values of the pixels of the second rendered frame to the depth values of the interpolated frame 122. Based on the comparison, interpolation circuitry 230 determines respective values for one or more pixels representing the level of disocclusion (e.g., how disoccluded the pixel became) from the viewpoint of the second rendered frame to the viewpoint of the interpolated frame 122. Using the multi-channel disocclusion mask 124, interpolation circuitry 230 then shades the interpolated frame 122. For example, interpolation circuitry 230 recertifies the color values of the interpolated frame 122 stored in a respective color buffer 220 based on the multi-channel disocclusion mask 124. To this end, as an example, interpolation circuitry 230 is configured to compare the values in a first channel of the multi-channel disocclusion mask 124 to a first occlusion threshold. Based on a first value of the first channel being greater than the first occlusion threshold, interpolation circuitry 230 reduces the influence of the color value of the pixel in the first rendered frame associated with the first values of the first channel by, for example, modulating the color value of the pixel by the first channel of multi-channel disocclusion mask 124, discarding the color value of the pixel, applying a weight to the color value of the pixel, or any combination thereof. Further, interpolation circuitry 230 is configured to compare the values in a second channel of the multi-channel disocclusion mask 124 to a second occlusion threshold. Based on a first value of the second channel being greater than the first occlusion threshold, interpolation circuitry 230 reduces the influence of the color value of the pixel in the second rendered frame associated with the first value of the second channel by, for example, modulating the color value of the pixel by the first channel of multi-channel disocclusion mask 124, discarding the color value of the pixel, applying a weight to the color value of the pixel, or any combination thereof. After interpolation circuitry 230 recertifies the color values of the interpolated frame 122, interpolation circuitry 230 stores the recertified color values in one or more output buffers for display on display 128, performs further post-processing techniques on the recertified color values, or both.

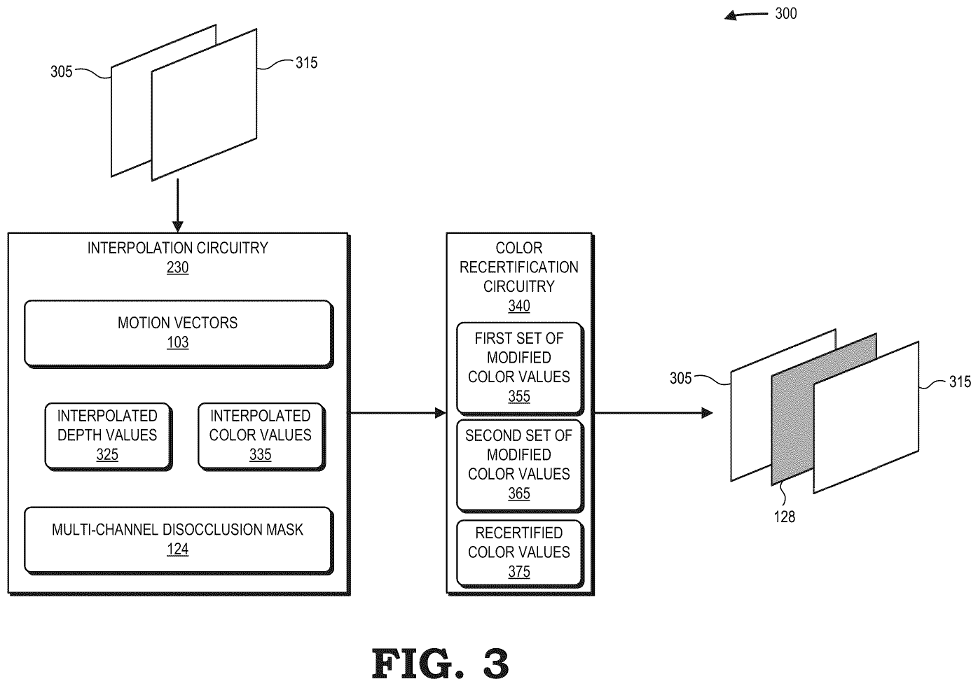

Referring now to FIG. 3, an example operation 300 for shading an interpolated frame 122 using a multi-channel disocclusion mask 124 is presented. In embodiments, example operation 300 is implemented by AU 112. According to embodiments, example operation 300 first includes interpolation circuitry 230 receiving pixel data associated with a first rendered frame 305 and a second rendered frame 315. For example, example operation 300 first includes interpolation circuitry 230 retrieving color data, depth data, stencil data, or any combination thereof associated with the first rendered frame 305 and the second rendered frame 315 from respective depth buffers 222. According to embodiments, the first rendered frame 305 and the second rendered frame 315 are part of a set of rendered frames 118 and each represent a respective scene having a respective viewpoint. Further, in some embodiments, the first rendered frame 305 immediately precedes the second rendered frame 315 in the set of rendered frames 118 such that the first rendered frame 305 and second rendered frame 315 represents scenes that are temporally adjacent, spatially adjacent, or both.

According to embodiments, example operation 300 includes interpolation circuitry 230 generating one or more motion vectors 103 based on the pixel data (e.g., color values, depth values, stencil values) associated with a first rendered frame 305 and a second rendered frame 315. Such motion vectors 103, for example, represent the movement of one or more pixels from a first viewpoint represented by the first rendered frame 305 to the second viewpoint represented by the second rendered frame 315. To generate one or more motion vectors 103, interpolation circuitry 230 is configured to implement one or more motion estimation techniques using the pixel data associated with a first rendered frame 305 and a second rendered frame 315 as inputs. As an example, interpolation circuitry 230 implements block-matching algorithms, phase correlation methods, pixel recursive algorithms, optical flow methods, or any combination thereof using the pixel values associated with the first rendered frame 305 and the pixel values of the second rendered frame 315 as inputs to output one or more motion vectors 103. In some embodiments, after generating one or more motion vectors 103, interpolation circuitry 230 is configured to store the motion vectors 103 in one or more motion vector buffers. Such motion vector buffers, for example, use at least a portion of storage resources 234. Based on the motion vectors 103, interpolation circuitry 230 is configured to generate an interpolated frame 122 representing a scene with a respective viewpoint that is temporally between, spatially between, or both the first rendered frame 305 and the second rendered frame 315. To this end, interpolation circuitry 230 generates interpolated depth values 325 and interpolated color values 335 for an interpolated frame 122 based on motion vectors 103, the pixel data associated with the first rendered frame 305, and the pixel data associated with the second rendered frame 315. For example, interpolation circuitry 230 implements one or more machine machine-learning models, neural networks (e.g., artificial neural networks, convolution neural networks, recurrent neural networks), or both configured to output interpolated depth values 325 and interpolated color values 335 based the motion vectors 103, the pixel data associated with the first rendered frame 305, and the pixel data associated with the second rendered frame 315. As an example, in some embodiments, interpolation circuitry 230 is configured to implement a depth-aware frame interpolation neural network to synthesize interpolated depth values 325 and interpolated color values 335.

To help reduce the number of visual artifacts, such as ghosting artifacts, in an interpolated frame 122 represented by interpolated depth values 325 and interpolated color values 335, example operation 300 includes shading the interpolated frame 122 based on a multi-channel disocclusion mask 124. That is to say, example operation 300 includes recertifying interpolated color values 335 based on a multi-channel disocclusion mask 124. To this end, interpolation circuitry 230 is first configured to generate a multi-channel disocclusion mask 124 having a first channel that includes values representing the levels of dis occlusion of pixels between the first rendered frame 305 and the interpolated frame 122 and having a second channel that includes values representing the levels of disocclusion of pixels between the interpolated frame 122 and the second rendered frame 315. Within example operation 300, to generate the multi-channel disocclusion mask 124, interpolation circuitry 230 is first configured to compare the depth values of pixels in the first rendered frame 305 to respective interpolated depth values 325 associated with the same pixel. As an example, interpolation circuitry 230 compares the depth value of pixels at estimated locations within first rendered frame 305 to interpolated depth values 325 at estimated locations within the interpolated frame 122 to which the pixels move from the first rendered frame 305 to determine respective differences (e.g., deltas) for each pixel. Interpolation circuitry 230 then compares the respective difference for a pixel to a separation threshold to determine a disocclusion value representing how disoccluded the pixel became from the first rendered frame 305 to the interpolated frame 122. Additionally, interpolation circuitry 230 is configured to compare the depth values of pixels of the second rendered frame 315 to respective interpolated depth values 325 associated with the same pixel. For example, interpolation circuitry 230 compares the depth values of pixels at locations within the second rendered frame 315 to interpolated depth values 325 at estimated locations within the interpolated frame 122 from which the pixels move to the second rendered frame 315 to determine respective differences (e.g., deltas) for each pixel. Interpolation circuitry 230 then compares the respective difference for a pixel to a separation threshold to determine a disocclusion value representing how disoccluded the pixel became from the interpolated frame 122 and the second rendered frame 315.

After interpolation circuitry 230 generates multi-channel disocclusion mask 124, example operation 300 includes color recertification circuitry 340, included in other otherwise connected to post-processing circuitry 120, recertifying interpolated color values 335. For example, in embodiments, color recertification circuitry 340 is configured to recertify interpolated color values 335 to produce updated color values by modifying one or more color values of the first rendered frame 305, the second rendered frame 315, or both based on multi-channel disocclusion mask 124. To this end, in embodiments, color recertification circuitry 340 is configured to modify the color values of the first rendered frame 305 by comparing the values in the first channel of the multi-channel disocclusion mask 124 to a first disocclusion threshold (e.g., a first threshold value). In response to a value of the first channel of the multi-channel disocclusion mask 124 being greater than the first disocclusion threshold, color recertification circuitry 340 determines that the pixel associated with the value was at least partially occluded (e.g., obscured) in the first rendered frame 305 before being disoccluded (e.g., unobscured) in the interpolated frame 122 by a threshold amount. Based on the pixel being disoccluded in the interpolated frame 122 from the first rendered frame 305 by a threshold level, color recertification circuitry 340 determines that the color value for the pixel in the first rendered frame 305 is not valid for increasing the quality of pixel in the interpolated frame 122. As such, in embodiments, color recertification circuitry 340 is configured to modify the color value of the pixel in the first rendered frame 305 by, for example, modulating the color value of the pixel by the first channel of multi-channel disocclusion mask 124, discarding the color value of the pixel, applying a weight to the color value of the pixel, or any combination thereof. Once color recertification circuitry 340 compares each value of the first channel of multi-channel disocclusion mask 124 to the first disocclusion threshold, color recertification circuitry 340 produces a first set of modified color values 355 representing the color values of the first rendered frame 305 as modified by color recertification circuitry 340.

Further, color recertification circuitry 340 is configured to modify the color values of the second rendered frame 315 by comparing the values in the second channel of the multi-channel disocclusion mask 124 to a second disocclusion threshold (e.g., a second threshold value). In some embodiments, the second disocclusion threshold is equal to the first disocclusion threshold, wherein in other embodiments, the second disocclusion threshold is different from the first disocclusion threshold. In response to a value of the second channel of the multi-channel disocclusion mask 124 being greater than the second disocclusion threshold, color recertification circuitry 340 determines that the pixel associated with the value is at least partially occluded (e.g., obscured) in the second rendered frame 315 and was previously disoccluded by a threshold amount in the interpolated frame 122. Based on the pixel having been disoccluded by a threshold amount in the interpolated frame 122 before being occluded in the second rendered frame 305, color recertification circuitry 340 determines that the color value for the pixel in the second rendered frame 315 is not valid for increasing the quality of pixel in the interpolated frame 122. As such, in embodiments, color recertification circuitry 340 is configured to modify the color value of the pixel in the second rendered frame 315 by, for example, modulating the color value of the pixel by the second channel of multi-channel disocclusion mask 124, discarding the color value of the pixel, applying a weight to the color value of the pixel, or any combination thereof. After color recertification circuitry 340 compares each value of the second channel of multi-channel disocclusion mask 124 to the second disocclusion threshold, color recertification circuitry 340 produces a second set of modified color values 365 representing the color values of the second rendered frame 315 as modified by color recertification circuitry 340.

Based on the first set of modified color values 355 and the second set of modified color values 365, color recertification circuitry 340 then generates recertified color values 375 for the interpolated frame 122. For example, interpolation circuitry 230 implements one or more machine machine-learning models, neural networks (e.g., artificial neural networks, convolution neural networks, recurrent neural networks), or both configured to output recertified color values 375 based the motion vectors 103, the first set of modified color values 355, and the second set of modified color values 365. For example, in some embodiments, interpolation circuitry 230 is configured to implement a depth-aware frame interpolation neural network to synthesize recertified color values 375 using the motion vectors 103, the first set of modified color values 355, and the second set of modified color values 365. After generating recertified color values 375, color recertification circuitry 340 stores recertified color values 375 in one or more output buffers for display on display 128, perform further post-processing techniques on the recertified color values, or both. As an example, color recertification circuitry 340 stores recertified color values 375 in one or more output buffers such that interpolated frame 122 is inserted between the first rendered frame 305 and the second rendered frame 315 within a set of rendered frames 118.

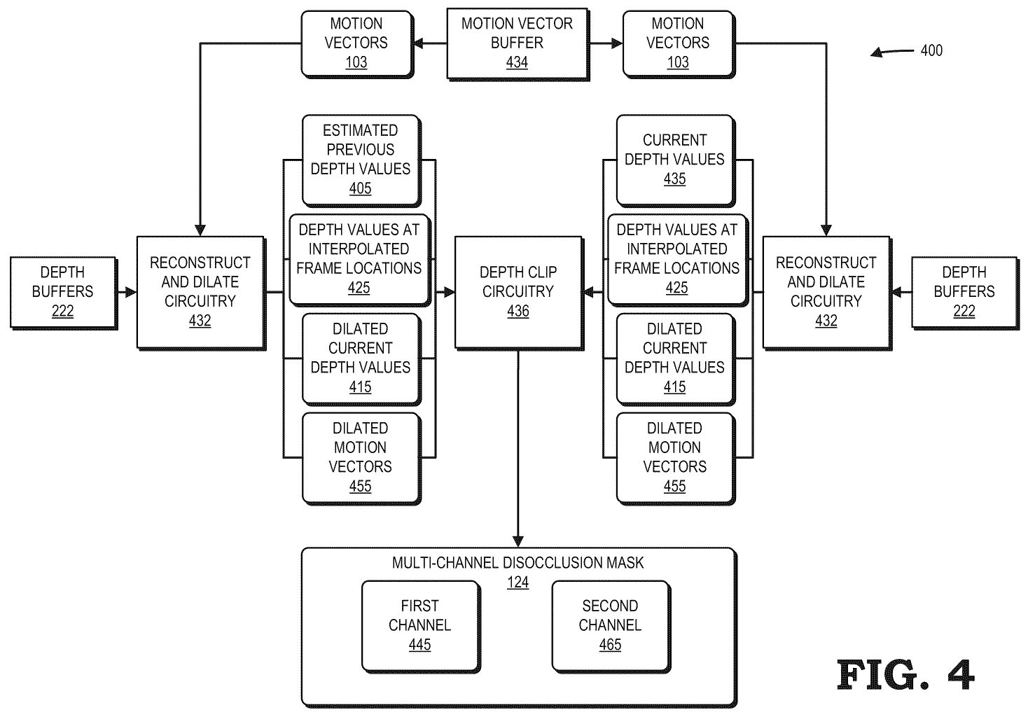

Referring now to FIG. 4, an example operation 400 for generating a multi-channel disocclusion mask is presented, in accordance with some embodiments. According to embodiments, example operation 400 includes reconstruct and dilate circuitry 432, included in or otherwise connected to post-processing circuitry 120, generating a multi-channel disocclusion mask 124 that represents the level of disocclusion for pixels between a previous rendered frame (e.g., first rendered frame 305) and an interpolated frame 122 generated using the previous rendered frame and the level of disocclusion for pixels between the interpolated frame 122 and a current rendered frame (e.g., second rendered frame 315) used to generated the interpolated frame 122. To this end, in embodiments, example operation 400 includes reconstruct and dilate circuitry 432 generating values that represent the level of disocclusion for pixels between the previous rendered frame and the interpolated frame 122. For example, within example operation 400, reconstruct and dilate circuitry 432 first retrieves current depth values 435 from one or more respective depth buffers 222 and retrieves motion vectors 103 associated with the previous rendered frame and the current rendered frame (e.g., motion vectors 103 used to generate the interpolated frame 122) from a motion vector buffer 434. Current depth values 435, for example, represents the depth values of the current rendered frame as retrieved from a respective depth buffer 222. Based on the retrieved current depth values 435 and motion vectors 103, reconstruct and dilate circuitry 432 determines dilated current depth values 415 representing dilated values for the pixels of the current rendered frame and also determines dilated motion vectors 455.

In embodiments, dilated current depth values 415 and dilated motion vectors 455 each include data emphasizing the edges of geometry (e.g., images, graphics objects) in the current rendered frame as represented by current depth values 435 as stored in one or more respective depth buffers 222. These edges of geometry, for example, often introduce discontinuities into a contiguous series of depth values. Therefore, as the depth values and motion vectors are dilated, they naturally follow the contours of the geometric edges present in current depth values 435 as stored in one or more respective depth buffers 222. According to embodiments, reconstruct and dilate circuitry 432 is configured to compute dilated current depth values 415 and dilated motion vectors 455 by considering the depth values of a respective pixel neighborhood around each pixel of the current frame as indicated by current depth values 435. Such a pixel neighborhood, for example, includes a first number of pixels in a first direction (e.g., 3) and a second number of pixels in a second direction (e.g., 3) with a corresponding pixel being in the center (e.g., the pixel around which the pixel neighborhood is being considered). Within the depth values of the pixels in a pixel neighborhood, reconstruct and dilate circuitry 432 selects the depth values and corresponding motion vectors of the pixel where the depth value is nearest (e.g., appears closest) to a viewpoint of the scene represented by the current rendered frame. Reconstruct and dilate circuitry 432 then updates the pixel in the center of the pixel neighborhood with the selected depth value and selects the corresponding motion vector 103.

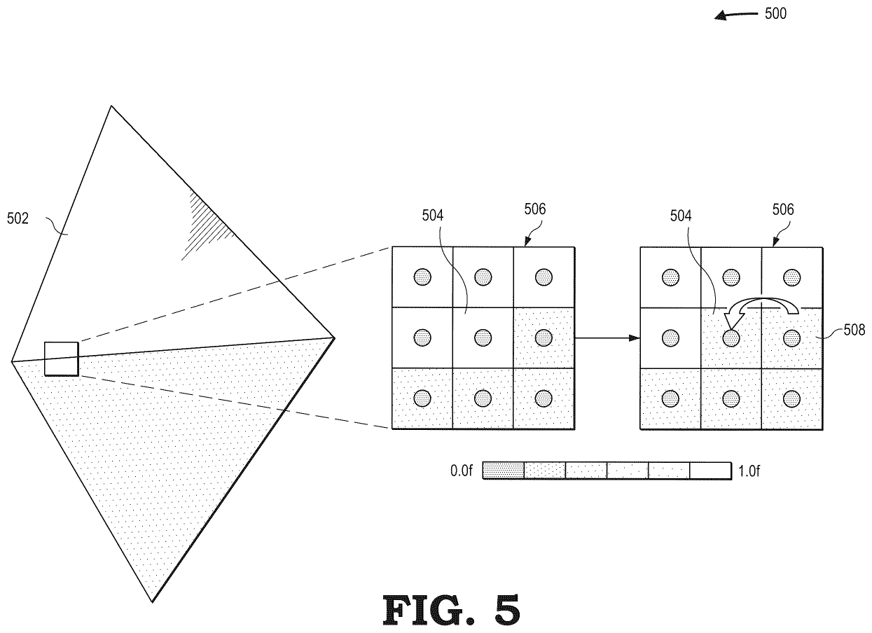

By updating each pixel of the current rendered frame based on a respective pixel neighborhood and selecting a corresponding motion vector 103 for the pixel based on the respective pixel neighborhood, reconstruct and dilate circuitry 432 computes dilated current depth values 415 and dilated motion vectors 455. As an example, FIG. 5 presents an example dilation operation 500. In some embodiments, example dilation operation 500 is included within example operation 400 and is implemented by, for example, reconstruct and dilate circuitry 432. Within the example dilation operation 500, a geometry 502 (e.g., an image, graphics object) of a current rendered frame includes a central pixel 504 surrounded by a 3×3 pixel neighborhood 506. The 3×3 pixel neighborhood 506, for example, includes a pixel 508 having depth values nearest to the viewpoint of the scene of the current rendered frame. In embodiments, example dilation operation 500 includes updating the central pixel 504 with the depth value and motion vectors from the pixel 508 based on the pixel 508 having depth values nearest to the viewpoint of the scene of the current rendered frame. Further, example dilation operation 500 includes reconstruct and dilate circuitry 432 storing the updated dilated depth values for the central pixel 504 in a respective depth buffer (e.g., a dilated depth buffer) and the determined dilated motion vectors in a respective motion vector buffer (e.g., a dilated motion vector buffer).

Referring again to FIG. 4, after reconstruct and dilate circuitry 432 determines dilated current depth values 415 and dilated motion vectors 455, example operation 400 includes reconstruct and dilate circuitry 432 determining estimated previous depth values 405 and depth values at interpolated frame locations 425 based on dilated current depth values 415 and dilated motion vectors 455. Depth values at interpolated frame locations 425, for example, represent the depth values for pixels in the interpolated frame 122 that move from estimated locations in the interpolated frame to current locations in the current frame. Additionally, estimated previous depth values 405, for example, represent the depth values for pixels in the previous rendered frame that move from estimated locations in the previous rendered frame to the estimated location in the interpolated frame 122. To this end, for example, reconstruct and dilate circuitry 432 is configured to estimate depth values at interpolated frame locations 425 using dilated current depth values 415 and dilated motion vectors 455. For example, reconstruct and dilate circuitry 432 applies a first scaling (e.g., 0.5) to the dilated motion vector 455 computed for a corresponding pixel in the current rendered frame and then applies the scaled dilated motion vector 455 to the value of the corresponding pixel as indicated in dilated current depth values 415 (e.g., as stored in a respective depth buffer) to determine the location of the pixel in the interpolated frame 122. Stated differently, each depth value of a pixel in dilated current depth values 415 is reprojected to its location in the interpoalted frame 122 using a scaled dilated motion vector 455 associated with the pixel (e.g., selected for the pixel). According to embodiments, the first scaling applied to the dilate motion vector 455 is based on the number interpolated frames 122 between the current rendered frame and the previous rendered frame. As an example, based on one interpolated frame 122 being between the current rendered frame and the previous rendered frame, the first scaling includes a first value (e.g., 0.5), while, based on two interpolated frames 122 being between the current rendered frame and the previous rendered frame, the first scaling includes a second value (e.g., 0.33) different from the first value.

Further, reconstruct and dilate circuitry 432 is configured to determine estimated previous depth values 405 at estimated locations within the previous rendered frame using dilated current depth values 415 and dilated motion vectors 455. As an example, reconstruct and dilate circuitry 432 applies a second scaling (e.g., 1) to the dilated motion vector 455 computed for a corresponding pixel in the current rendered frame and then applies the scaled dilated motion vector 455 to the value of the corresponding pixel as indicated in dilated current depth values 415 (e.g., as stored in a respective depth buffer) to determine the location of the pixel in the previous rendered frame. Stated differently, each depth value of a pixel in the current rendered frame is reprojected to its location in the previous rendered frame using a scaled dilated motion vector 455 associated with the pixel (e.g., selected for the pixel).

In embodiments, one or more depth values of dilated current depth values 415 are scattered among impacted depth values using, for example, backward or reverse reprojection. Because, in some embodiments, many pixels of the current rendered frame reproject into the same pixel of the interpolated frame 122, previous rendered frame, or both, reconstruct and dilate circuitry 432 uses atomic operations to resolve the value of the nearest depth value for each pixel. As an example, in embodiments, reconstruct and dilate circuitry 432 uses atomic operations including, for example, InterlockedMax or InterlockedMin provided by the High-Level Shader Language (HLSL) or comparable equivalents. According to some embodiments, reconstruct and dilate circuitry 432 performs different atomic operations (e.g., InterlockedMax or InterlockedMin) depending on whether the depth buffer storing dilated current depth values 415 is inverted or non-inverted. Reconstruct and dilate circuitry 432 then stores the reconstructed/determined depth values in a respective depth buffer as estimated previous depth values 405.

After reconstruct and dilate circuitry 432 generates estimated previous depth values 405 and depth values at interpolated frame locations 425, example operation 400 includes depth clip circuitry 436, included in or otherwise connected to post-processing circuitry 120, determining values representing the levels of disocclusion of pixels from the viewpoint of the previous rendered frame to the viewpoint of the interpolated frame. To this end, depth clip circuitry 436 is configured to generate such values based on estimated previous depth values 405 and depth values at interpolated frame locations 425. As an example, based on estimated previous depth values 405 and depth values at interpolated frame locations 425, depth clip circuitry 436 determines the respective first depth value for each pixel at a respective first position in the previous rendered frame and a respective second depth value for each pixel at a respective second position in the interpolated frame 122. Depth clip circuitry 436 then determines a respective difference (e.g., delta) for each pixel by comparing the corresponding first depth value of a pixel to the corresponding second depth value of the pixel and compares these respective differences to a separation threshold (e.g., Akeley separation constant). According to embodiments, based on depth clip circuitry 436 determining that the respective difference of a pixel is larger than the separation threshold, depth clip circuitry 436 determines the difference represents distinct graphics objects moving within the pixel. However, based on depth clip circuitry 436 determining that the respective difference does not exceed the separation value, depth clip circuitry 436 is unable to confidently determine that the difference represents distinct graphics objects moving within the pixel. Further, based on the comparison to the separation threshold, depth clip circuitry 436 stores a value in the first channel 445 of multi-channel disocclusion mask 124 for the pixel associated with the compared difference in a range including a first value (e.g., 0) and a second value (e.g., 1). For example, based on a difference associated with a pixel being greater than or equal to the separation threshold, depth clip circuitry 436 stores a second value (e.g., 1) in the first channel 445 of multi-channel disocclusion mask 124. In this way, as an example, depth clip circuitry 436 populates the first channel 445 of multi-channel disocclusion mask 124 with values representing the levels of disocclusion of pixels from the viewpoint of the previous rendered frame to the viewpoint of the interpolated frame 122.

Additionally, example operation 400 includes depth clip circuitry 436 determining values representing the levels of disocclusion of pixels from the viewpoint of the current frame to the viewpoint of the interpolated frame 122. To this end, reconstruct and dilate circuitry 432 is configured to estimate depth values of the interpolated frame 122 (e.g., depth values at interpolated frame locations 425) based on dilated current depth values 415 and dilated motion vectors 455. As an example, reconstruct and dilate circuitry 432 applies a first scaling (e.g., 0.5) to the dilated motion vector 455 computed for a corresponding pixel in the current rendered frame and applies the scaled dilated motion vector 455 to its value indicated in dilated current depth values 415 (e.g., as stored in a respective depth buffer) to determine the location of the pixel in the interpolated frame 122. After determining depth location at interpolated frame locations 425, depth clip circuitry 436 then determines a respective difference (e.g., delta) for each pixel that moves between the interpolated frame 122 and the current frame by comparing the depth value of the pixel at an estimated position in interpolated frame 122 (e.g., as indicated by depth values at interpolated frame locations 425) to the depth value of the pixel at a current position in the current frame. Further, depth clip circuitry 436 compares these determined differences to a separation threshold (e.g., Akeley separation constant). Based on depth clip circuitry 436 determining that the respective difference of a pixel is larger than the separation threshold, depth clip circuitry 436 determines the difference represents distinct graphics objects moving within the pixel. However, based on depth clip circuitry 436 determining that the respective difference does not exceed the separation value, depth clip circuitry 436 is unable to confidently determine that the difference represents distinct graphics objects moving within the pixel. According to embodiments, based on the comparison to the separation threshold, depth clip circuitry 436 stores a value in the second channel 465 of multi-channel disocclusion mask 124 for the pixel associated with the compared difference in a range including a first value (e.g., 0) and a second value (e.g., 1). For example, based on a difference associated with a pixel being greater than or equal to the separation threshold, depth clip circuitry 436 stored a second value (e.g., 1) in the second channel 465 of multi-channel disocclusion mask 124. In this way, for example, depth clip circuitry 436 populates the second channel 465 of multi-channel disocclusion mask 124 with values representing the levels of disocclusion of pixels from the viewpoint of the current frame to the viewpoint of the interpolated frame 122. After populating both the first channel 445 and second channel 465 of multi-channel disocclusion mask 124, processing system 100 is configured to shade the interpolated frame 122. That is to say, processing system 100 is configured to recertify the color values of interpolated frame 122 based on the first channel 445 and second channel 465 of multi-channel disocclusion mask 124.

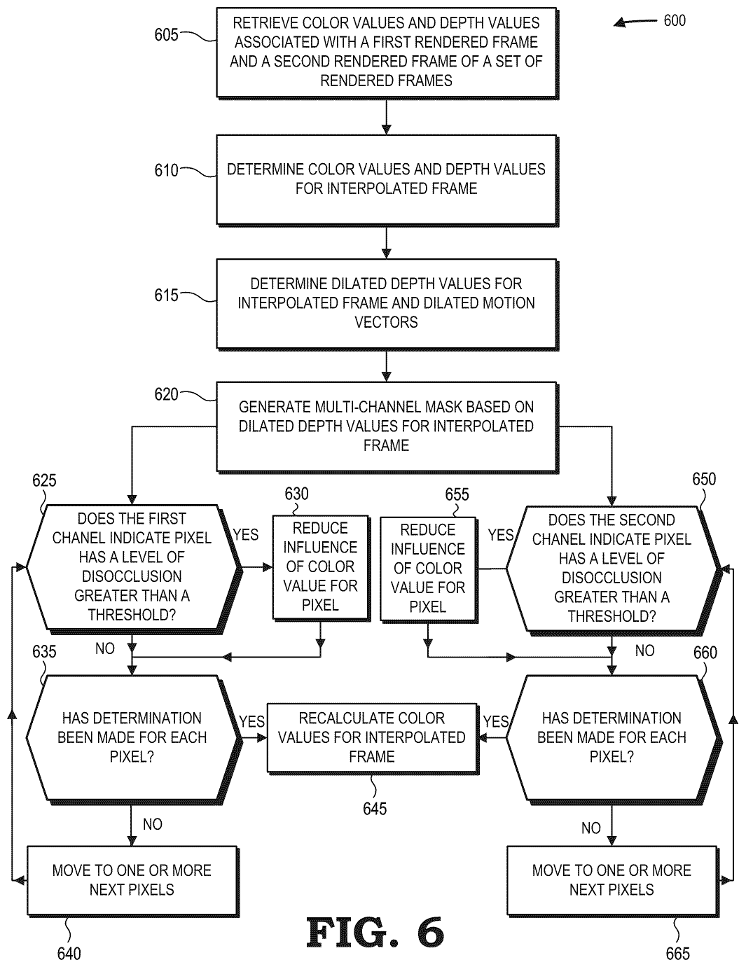

Referring now to FIG. 6, an example method 600 for shading an interpolated frame 122 using a multi-channel disocclusion mask 124 is presented, in accordance with some embodiments. In embodiments, example method 600 includes, at block 605, AU 112 retrieving color values and depth values for a first rendered frame (e.g., previous rendered frame) and a second rendered frame (e.g., current rendered frame) of a rendered set of rendered frames 118. For example, AU 112 retrieves colors values and depth values for the first rendered frame from a first color buffer 220 and a first depth buffer 222 and colors values and depth values for the second rendered frame from a second color buffer 220 and a second depth buffer 222. After retrieving the color values and the depth values for the first rendered frame and the second rendered frame, at block 610, AU 112 generates an interpolated frame 122 representing a scene temporally between, spatially between, or both, the first and second rendered frame. For example, AU 112 generates an interpolated frame 122 based on the color values and the depth values of the first and second rendered frames. To this end, as an example, still referring to block 610, AU 112 is configured to generate one or more motion vectors 103 based on the color values and the depth values of the first and second rendered frames. As an example, AU 112 implements one or more motion estimation techniques (e.g., block-matching algorithms, phase correlation methods, pixel recursive algorithms, optical flow methods) using the color values and the depth values of the first and second rendered frames as inputs to generate one or more motion vectors 103. Based on the motion vectors 103, AU 112 then synthesizes the color values and depth values of the interpolated frame 122. For example, AU 112 implements one or more machine machine-learning models, neural networks (e.g., artificial neural networks, convolution neural networks, recurrent neural networks), or both configured to output color values and depth values for each pixel of the interpolated frame 122 based on receiving the motion vectors 103, the color values of the first and second frames, and the depth values of the first and second frames as inputs.

Still referring to block 610, once AU 112 has determined the color values and depth values of the interpolated frame 122, AU 112 stores the color values of the interpolated frame 122 in a respective color buffer 220 and the depth values of the interpolated frame 122 (e.g., interpolated depth values 325) in a respective depth buffer 222. At block 615 of example method 600, AU 112 determines dilated depth values for the second rendered frame (e.g., dilated current depth values 415) and dilated motion vectors (e.g., dilated motion vectors 455) based on the motion vectors 103 and the depth values of the second rendered frame. As an example, AU 112 implements a dilate operation similar to or the same as example dilation operation 500 using the motion vectors 103 and the depth values of the second rendered frame as inputs. Based on the motion vectors 103 and the depth values of the second rendered frame, the dilate operation implemented by AU 112 returns, for example, dilated depth values for the second rendered frame and dilated motion vectors.

After AU 112 has determined the dilated depth values for the second rendered frame and the dilated motion vectors, at block 620, AU 112 generates a multi-channel disocclusion mask 124 based on the dilated depth values for the second rendered frame and the dilated motion vectors. For example, based on the dilated depth values for the second rendered frame and the dilated motion vectors, AU 112 estimates the positions of pixels in the interpolated frame 122 generated at block 610 associated with pixels in the second rendered frame. As an example, AU 112 estimates the second positions of pixels in the interpolated frame 122 that move to current locations in the second rendered frame. Additionally, based on the dilated depth values for the second rendered frame and the dilated motion vectors, AU 112 estimates the positions of pixels in the first rendered frame associated with pixels in the second rendered frame. For example, AU 112 estimates the first positions of pixels in the interpolated frame 122 that move to second locations in the interpolated frame 122 and then to current positions in the second rendered frame. After estimating the first positions of pixels in the first rendered frame, AU 112 determines a difference for each pixel representing the depth value of the pixel at a first position in the first rendered frame and the depth value of the pixel at a second position in the interpolated frame 122. AU 112 then compares the difference to a threshold value (e.g., separation threshold) to determine how disoccluded (e.g., unobscured) the pixel becomes when it moves from the first position in the first rendered frame to the second position in the interpolated frame 122. That is to say, AU 112 compares the difference to a threshold value to determine a value representing the level of discussion for the pixel. AU 112 then stores these values representing the level of discussion for the pixel in a first channel 445 of multi-channel disocclusion mask 124. In this way, the first channel 445 of multi-channel disocclusion mask 124 represents how disoccluded pixels become moving from respective first positions in the first rendered frame to respective second positions in the interpolated frame 122.

Additionally, at block 620, AU 112 determines a difference for each pixel representing the depth value of the pixel at a second position in the interpolated frame 122 and the depth value of the pixel at a current position in the second rendered frame. AU 112 then compares the difference to a threshold value (e.g., separation threshold) to determine the level of disocclusion of the pixel moving from the first position in the interpolated frame 122 to the second position in the second rendered frame (e.g., how occluded the pixel becomes moving from the interpolated frame 122 to the second rendered frame). AU 112 then stores these values representing the level of disocclusion for the pixel in a second channel 465 of multi-channel disocclusion mask 124. In this way, the second channel 465 of multi-channel disocclusion mask 124 represents, for example, how disoccluded pixels become moving from respective second positions in the second rendered frame to respective first positions in the interpolated frame 122.

Within example method 600, AU 112 then recertifies the color values of the interpolated frame 122 based on the multi-channel disocclusion mask 124. For example, at block 625, AU 112 first determines whether the first channel 445 of multi-channel disocclusion mask 124 indicates that a pixel in the first rendered frame is occluded more than threshold value. That is to say, AU 112 determines whether the first channel 445 of multi-channel disocclusion mask 124 indicates that the level of disocclusion associated with a pixel in the first rendered frame is above a first disocclusion threshold. Based on the first channel 445 of multi-channel disocclusion mask 124 indicating that the level of disocclusion associated with a pixel in the first rendered frame is above a first disocclusion threshold, at block 630, AU 112 reduces the influence of the color value of the pixel on the interpolated frame 122 by modifying the color value. For example, AU 112 modulates the color value of the pixel by the first channel of multi-channel disocclusion mask 124, discards the color value of the pixel, applies a weight to the color value of the pixel, or any combination thereof. After modifying the color value of the pixel, AU 112 stores the modified color value in, for example, a first set of modified color values 355. Referring again to block 625, based on the first channel 445 of multi-channel disocclusion mask 124 indicating that the level of disocclusion associated with a pixel in the first rendered frame is not above a first disocclusion threshold, AU 112 moves to block 635. At block 635, AU 112 determines if a determination has been made for each pixel represented by the first channel of multi-channel disocclusion mask 124. That is to say, AU 112 determines each value in the first channel of multi-channel disocclusion mask 124 has been compared to the first disocclusion threshold. Based on a determination not having been made for each pixel represented by the first channel of multi-channel disocclusion mask 124, at block 640, AU 112 moves to a next pixel (e.g., a next values in the first channel of multi-channel disocclusion mask 124) and repeats block 625. Based on a determination having been made for each pixel represented by the first channel of multi-channel disocclusion mask 124, AU 112 moves to block 645.

Further at block 650, AU 112 first determines whether the second channel 465 of multi-channel disocclusion mask 124 indicates that a pixel in the second rendered frame is occluded more than threshold value. For example, AU 112 determines whether the second channel 465 of multi-channel disocclusion mask 124 indicates that the level of disocclusion associated with a pixel in the second rendered frame is above a second disocclusion threshold. Based on the second channel 465 of multi-channel disocclusion mask 124 indicating that the level of disocclusion associated with a pixel in the second rendered frame is above a first disocclusion threshold, at block 655, AU 112 reduces the influence of the color value of the pixel on the interpolated frame 122 by modifying the color value. As an example, AU 112 modulates the color value of the pixel by the second channel 465 of multi-channel disocclusion mask 124, discards the color value of the pixel, applies a weight to the color value of the pixel, or any combination thereof. After modifying the color value of the pixel, AU 112 stores the modified color value in, for example, a second set of modified color values 365. Referring again to block 650, based on the second channel 465 of multi-channel disocclusion mask 124 indicating that the level of disocclusion associated with a pixel in the second rendered frame is not above a second disocclusion threshold, AU 112 moves to block 660. At block 660, AU 112 determines if a determination has been made for each pixel represented by the second channel 465 of multi-channel disocclusion mask 124. Based on a determination not having been made for each pixel represented by the second channel of multi-channel disocclusion mask 124, at block 665, AU 112 moves to a next pixel (e.g., a next values in the second channel 465 of multi-channel disocclusion mask 124) and repeats block 650. Based on a determination having been made for each pixel represented by the second channel 465 of multi-channel disocclusion mask 124, AU 112 moves to block 645.

According to embodiments, AU 112 is configured to perform one or more of blocks 625, 630, 635, 640, or any combination thereof concurrently with performing one or more of blocks 650, 655, 660, 665, or any combination thereof. At block 645, AU 112 is configured to recertify the color values of the interpolated frame 122 based on sets of color values produced by modifying one or more color values at blocks 630 and 655. For example, AU 112 is configured to recertify the color values of the interpolated frame 122 based on the first set of modified color values 355 and the second set of modified color values 365. As an example, AU 112 recalculates the color values of interpolated frame 122 using the first set of modified color values 355 and the second set of modified color values 365.

In some embodiments, the apparatus and techniques described above are implemented in a system including one or more integrated circuit (IC) devices (also referred to as integrated circuit packages or microchips), such as the AU 112 described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system comprising:
an accelerator unit (AU) configured to:
generate an interpolated frame based on a first rendered frame and a second rendered frame; and
recalculate one or more color values of the interpolated frame based on a multi-channel disocclusion mask associated with the first rendered frame and the second rendered frame.

2. The processing system of claim 1, wherein the multi-channel disocclusion mask includes:
a first channel that indicates levels of disocclusion associated with the first rendered frame and the interpolated frame; and
a second channel that indicates levels of disocclusion associated with the second rendered frame and the interpolated frame.

3. The processing system of claim 2, wherein the AU is configured to:
determine one or more depth values of the first rendered frame based on one or more dilated depth values of the second rendered frame; and
populate the first channel with a first set of values based on the determined depth values of the first rendered frame.

4. The processing system of claim 3, wherein the AU is configured to:
determine one or more depth values of the interpolated frame based on the one or more dilated depth values of the second rendered frame; and
populate the second channel with a second set of values based on the determined depth values of the interpolated frame.

5. The processing system of claim 2, wherein the AU is configured to:
modify one or more color values of the first rendered frame based on the first channel of the multi-channel disocclusion mask.

6. The processing system of claim 5, wherein the AU is configured to:
modify one or more color values of the second rendered frame based on the second channel of the multi-channel disocclusion mask.

7. The processing system of claim 6, wherein the AU is configured to:
recalculate the one or more color values of the interpolated frame by determining one or more updated color values based on the modified one or more color values of the first rendered frame and the modified one or more color values of the second rendered frame.

8. A method, comprising:
generating an interpolated frame based on a first rendered frame and a second rendered frame; and
recalculating one or more color values of the interpolated frame based on a multi-channel disocclusion mask associated with the first rendered frame and the second rendered frame.

9. The method of claim 8, wherein the multi-channel disocclusion mask includes a first channel that indicates levels of disocclusion associated with the first rendered frame and the interpolated frame and a second channel indicating levels of disocclusion associated with the second rendered frame and the interpolated frame.

10. The method of claim 9, further comprising:
determining one or more depth values of the first rendered frame based on one or more dilated depth values of the second rendered frame; and
populating the first channel with a first set of values based on the determined depth values of the first rendered frame.

11. The method of claim 10, further comprising:
determining one or more depth values of the interpolated frame based on one or more dilated depth values of the second rendered frame; and
populating the second channel with a second set of values based on the determined depth values of the interpolated frame.

12. The method of claim 9, further comprising:
modifying one or more color values of the first rendered frame based on the first channel of the multi-channel disocclusion mask.

13. The method of claim 12, further comprising:
modifying one or more color values of the second rendered frame based on the first channel of the multi-channel disocclusion mask.

14. The method of claim 13, wherein recertifying the one or more color values of the interpolated frame includes determining one or more updated color values based on the modified one or more color values of the first rendered frame and the modified one or more color values of the second rendered frame.

15. A processing system comprising:
a processor including one or more processor cores configured to:
determine depth values of a first rendered frame and depth values of an interpolated frame based on a second rendered frame; and
generate values for a first channel of a multi-channel disocclusion mask and values for a second channel of the multi-channel disocclusion mask based on the determined depth values of the first rendered frame and the determined depth values of the interpolated frame.

16. The processing system of claim 15, wherein the one or more processor cores are configured to:
recalculate one or more color values of the interpolated frame based on the multi-channel disocclusion mask.

17. The processing system of claim 15, wherein:
the first channel indicates levels of disocclusion associated with the first rendered frame and the interpolated frame; and
the second channel indicates levels of disocclusion associated with the second rendered frame and the interpolated frame.

18. The processing system of claim 15, wherein the one or more processor cores are configured to:
modify one or more color values of the first rendered frame based on the first channel of the multi-channel disocclusion mask.

19. The processing system of claim 18, wherein the one or more processor cores are configured to:
modify one or more color values of the second rendered frame based on the second channel of the multi-channel disocclusion mask.

20. The processing system of claim 19, wherein the one or more processor cores are configured to:
determine one or more updated color values for the interpolated frame based on the modified one or more color values of the first rendered frame and the modified one or more color values of the second rendered frame.
